(19) United States
(12) Patent Application Publication
(10) Pub. No.: US 2026/0159368 A1
(43) Pub. Date: Jun. 11, 2026

(54) APPARATUS FOR OPENING TAMPER-RESISTANT CONTAINERS

(71) Applicant: Chicken Tramper Ultralight Gear, LLC, Hancock, MI (US)

(72) Inventors: Nathan Ackerman, Hancock, MI (US); Austin Gongos, Hancock, MI (US)

(21) Appl. No.: 19/183,328

(22) Filed: Apr. 18, 2025

Related U.S. Application Data
(60) Provisional application No. 63/636,539, filed on Apr. 19, 2024.

(51) Int. Cl. B67B 7/18

(52) U.S. Cl. CPC B67B 7/18

(57) ABSTRACT

An apparatus for opening a tamper-resistant container includes an elongate body configured to fit against a sidewall of a tamper-resistant container body and a protrusion extending substantially perpendicularly from the elongate body. The protrusion includes a cavity on its underside surface configured to fit over a stopping mechanism of the tamper-resistant container body. When the protrusion is fitted over the stopping mechanism, the apparatus remains in place and allows a user to turn a lid of the tamper-resistant container. Turning the lid causes the protrusion to depress a flexible portion of the lid, enabling lid protrusions to slide past the stopping mechanism and allowing the lid to be released from the tamper-resistant container body.

### CROSS REFERENCE TO RELATED APPLICATIONS

This application claims priority to and the benefit of U.S. patent application Ser. No. 63/636,539, filed Apr. 19, 2024, which is herein incorporated by reference in its entirety.

### BACKGROUND OF THE DISCLOSURE

When hiking and backpacking in areas that are known to have bears, it is recommended, and often required, for people to use a bear proof container for storage of all food and toiletries. These containers or canisters, colloquially called “bear cans”, are intended to provide a safe place to store food should it be discovered by a bear. The containers typically have some sort of locking mechanism such as an internal latch or barbed lid, with a stopping mechanism on the can body, similar to some child proof containers. These locking mechanisms allow the user to open and close the container, but prevent the bears from getting in.

Bear cans or other tamper-resistant containers with bear-proof locking mechanisms can be extremely difficult to open. Conventional methods of opening these containers require users to manually press the lid's flexible portions to disengage the barbs while simultaneously rotating the lid, which can be cumbersome and require both hands. This may be especially true in cold conditions, where the containers become cold and stiff, and the user's fingers may be cold, or if the user is wearing gloves. In fact, it can be difficult for even the most experienced backpacker to open a bear can due, for instance, to the size of the bear can lid, and/or the forces required to be applied in different directions at the same time to open the lid. Often the user needs to hold the body of the can between their legs or under their arm, while pushing on and turning the lid with both hands. This can take several minutes to do, and it can be extremely frustrating for a user.

Improvements are needed.

### SUMMARY OF THE DISCLOSURE

The present disclosure provides a device for opening a tamper-resistant container such as bear can. The device is configured to facilitate the easy opening of tamper-resistant food containers, where the tamper-resistant mechanism securely joins the container lid and the container body. The device is small, portable, and ergonomic and simplifies the process of opening tamper-resistant containers by effectively bypassing the locking mechanism that secures the lid to the container by without compromising the integrity of the container itself.

In some embodiments, the device comprises an elongate body configured to fit against a container body and a protrusion extending perpendicularly from the elongate body. The protrusion includes an underside cavity or depression configured to fit over the container's stopping mechanism. When placed in position, the device remains secure, allowing the user to rotate the lid of the container with one hand. The protrusion depresses the lid's flexible portions, enabling barbs located on the container lid to bypass the stopping mechanism, and allowing the lid to be removed easily.

In other embodiments, the device is formed as a cap including an underside cavity or depression configured to fit over the container's stopping mechanism. When placed in position, the device remains secure, allowing the user to rotate the lid of the container with one hand. The protrusion depresses the lid's flexible portions, enabling barbs located on the container lid to bypass the stopping mechanism, and allowing the lid to be removed easily.

The device may be configured to work with both standard barb-based tamper-resistant container and those with rotating disc locks. To this end, in an additional embodiment, the device may include an auxiliary tab designed to interact with rotating lock mechanisms found on some tamper-resistant containers or canisters.

The present disclosure further includes a method of manufacturing the device, which includes forming the elongate body and protrusion, forming a cavity shaped to engage the stopping mechanism, and selecting materials that provide sufficient rigidity while maintaining lightweight portability.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of the tamper-resistant container opener, illustrating the protrusion and its underside cavity according to embodiments of the disclosure.

FIG. 2 is an additional perspective view of the opener, showing the elongate body and protrusion according to embodiments of the disclosure.

FIG. 3 is an additional perspective view of the opener, showing the overall shape and attachment features according to embodiments of the disclosure.

FIG. 4 is an additional perspective view of the opener including an auxiliary tab according to embodiments of the disclosure.

FIG. 5 is an additional perspective view of the opener including an auxiliary tab according to embodiments of the disclosure.

FIG. 6 is an additional perspective view of the opener including an auxiliary tab according to embodiments of the disclosure.

FIG. 7 is an exploded view of the opener in relation to a user according to embodiments of the disclosure.

FIG. 8 is a sectional view illustrating the engagement of the opener with the tamper-resistant container stopping mechanism during lid rotation according to embodiments of the disclosure.

FIG. 9 is an additional sectional view illustrating the engagement of the opener with the tamper-resistant container stopping mechanism during lid rotation according to embodiments of the disclosure.

FIG. 10 is an additional sectional view illustrating the engagement of the opener with the tamper-resistant container stopping mechanism during lid rotation according to embodiments of the disclosure.

FIG. 11 is an additional sectional view illustrating the engagement of the opener with the tamper-resistant container stopping mechanism during lid rotation according to embodiments of the disclosure.

FIG. 12 is an additional sectional view illustrating the engagement of the opener with the tamper-resistant container stopping mechanism during lid rotation according to embodiments of the disclosure.

FIG. 13 is an additional sectional view illustrating the engagement of the opener with the tamper-resistant container stopping mechanism during lid rotation according to embodiments of the disclosure.

FIG. 14 is a top view illustrating the engagement of the opener with the tamper-resistant container stopping mechanism during lid rotation according to embodiments of the disclosure.

FIG. 15 is a sectional view illustrating an underside of the container lid according to embodiments of the disclosure.

FIG. 16 is a perspective view of an attachment assembly according to embodiments of the disclosure.

FIG. 17 is an additional perspective view of the attachment assembly according to embodiments of the disclosure.

FIG. 18 is a perspective view of the tamper-resistant container opener, illustrating an additional embodiment of the disclosure.

FIG. 19 is an additional perspective view of the opener of FIG. 18 according to embodiments of the disclosure.

FIG. 20 is a flowchart of an example method of manufacturing a device for opening a tamper-resistant container according to embodiments of the disclosure.

### DESCRIPTION OF THE DISCLOSURE

Embodiments of the disclosure are directed to an opening device for a tamper-resistant can or canister such as a bear can. The device is designed to alleviate the difficulty in opening “barbed lid” style tamper-resistant containers. This style of container typically includes a lid having barbs or protrusions on the lid sidewall that extend outward over the lip of the can body. The body (e.g., the portion of the container configured to receive items needing to be stored) of this style of tamper-resistant container typically includes a stopping mechanism that prevents the container from being opened when the lid is secured to the body by stopping the motion of the lid when a barb hits the stopping mechanism. In such tamper-resistant containers, an area around the protrusions is more flexible than the surrounding material such that, when depressed, it pushes the barbs in, enabling them to slide along a path inside the stopping mechanism, thereby allowing the lid to release from the can body when all protrusions have moved beyond the stopping mechanism. While the disclosure is directed to an opening device for the style of bear can described herein, the device may be utilized with any lid/container combination having the same or similar tamper-resistant lid.

Referring generally to the figures, a device for opening a tamper-resistant container comprises an elongate body 102. Elongate body 102 may have a length of approximately 1 inch, a width of 0.75 inches, and a thickness of 0.25 inches. Other appropriate dimensions are contemplated. For instance, dimensions within approximately 0.25-0.5 inches greater or smaller than those provided are also contemplated. The elongate body 102 is shaped to fit against the sidewall of a container body during use. The elongate body 102 may be slightly curved body or otherwise configured to fit or rest flush against the sidewall of a container body for stability and ease of use. Thus, the elongate body 102 provides a stable grip or leverage for the device 100 in operation.

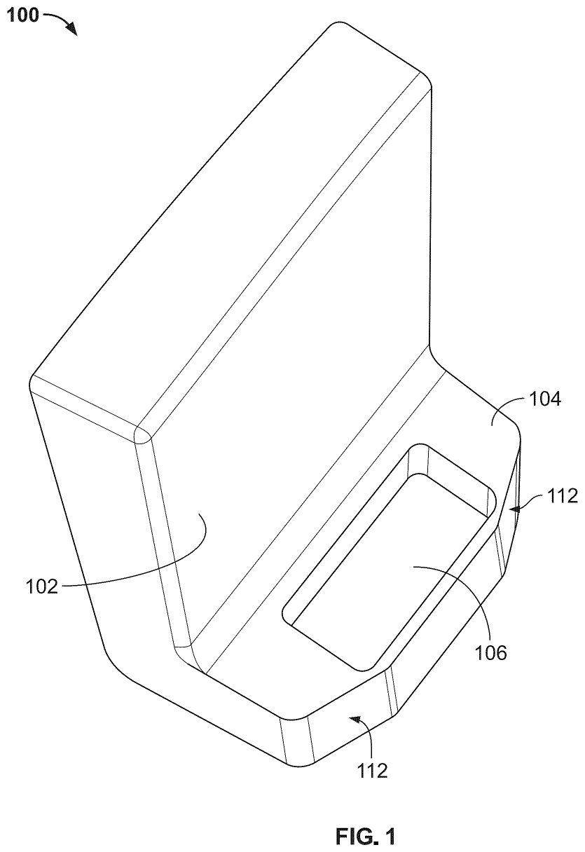

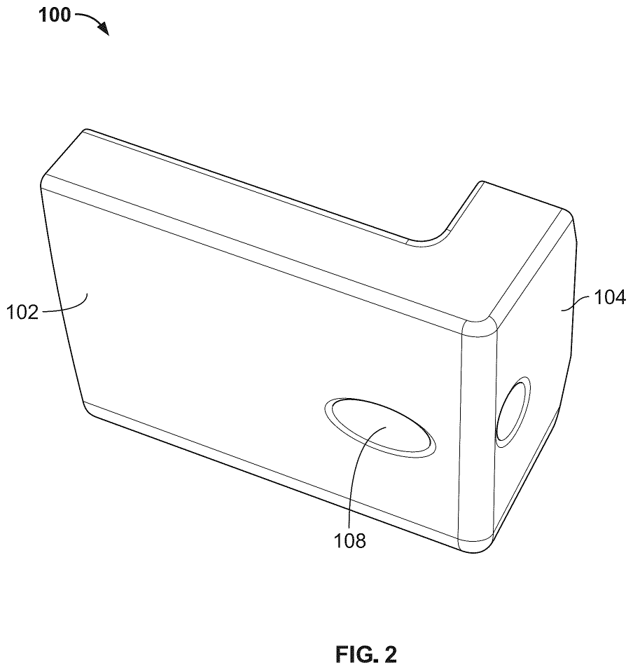

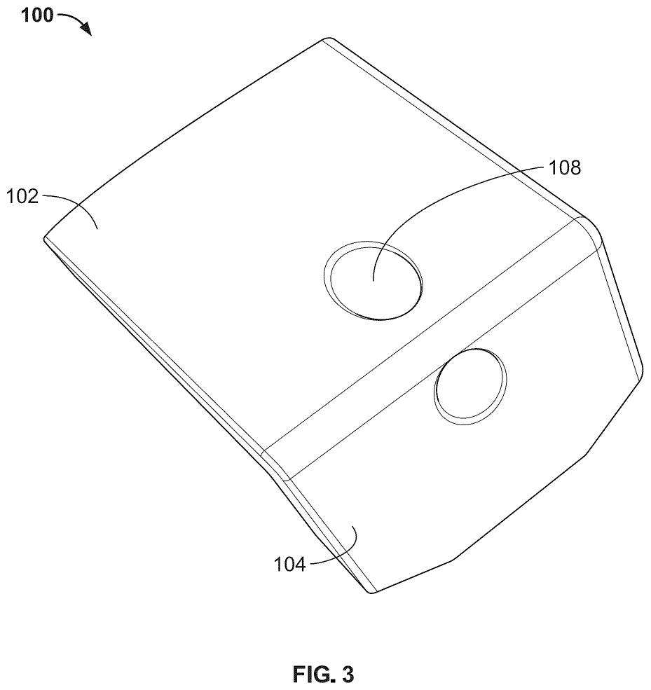

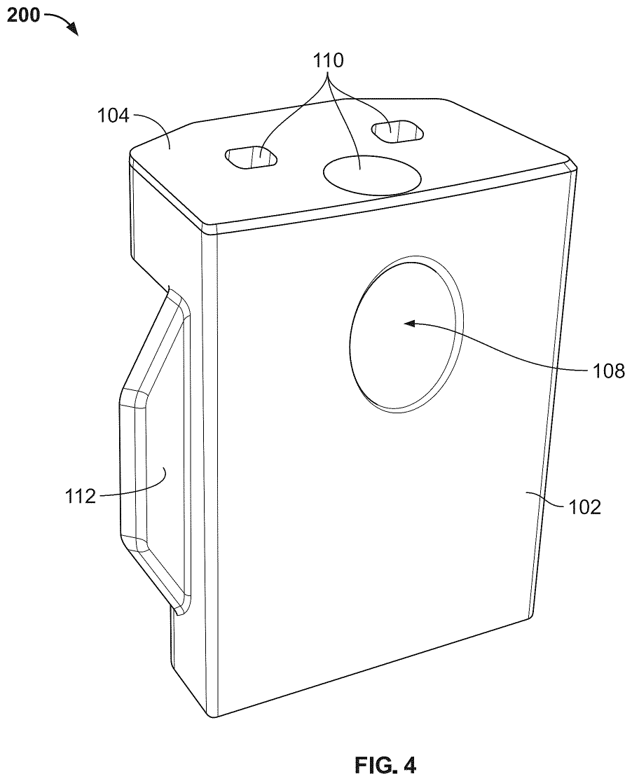

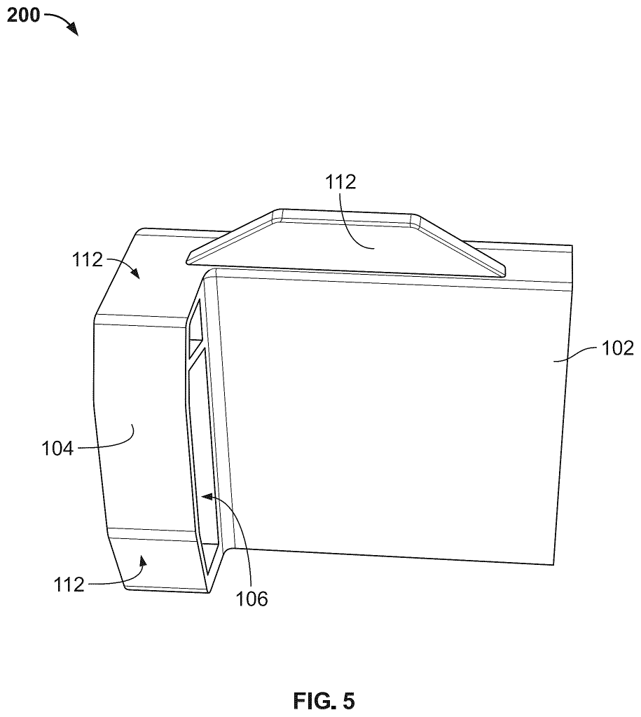

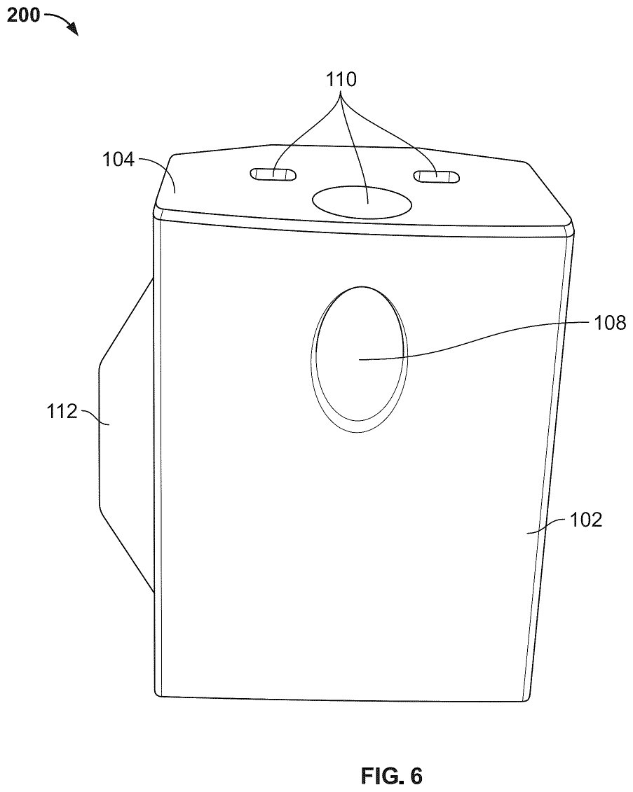

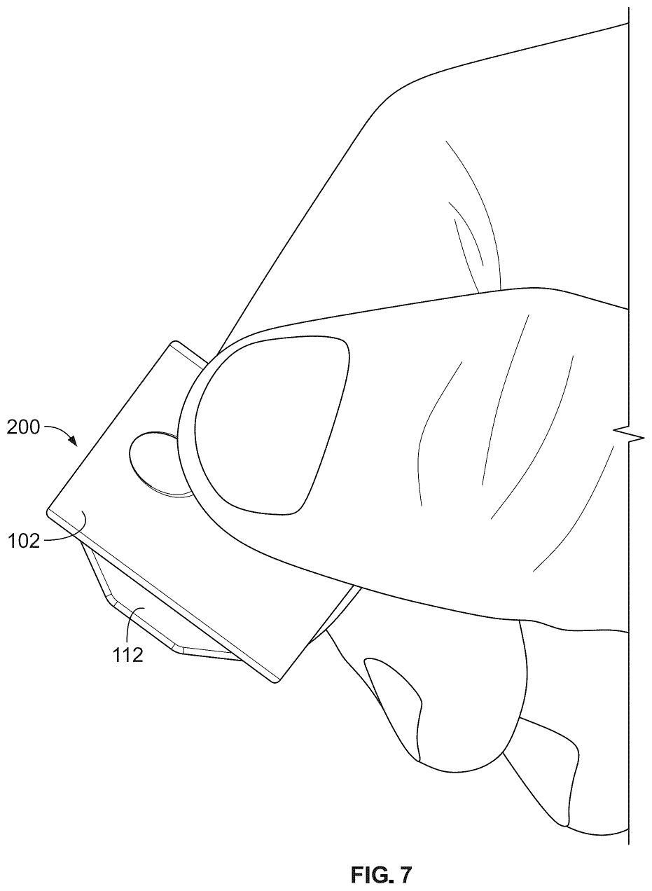

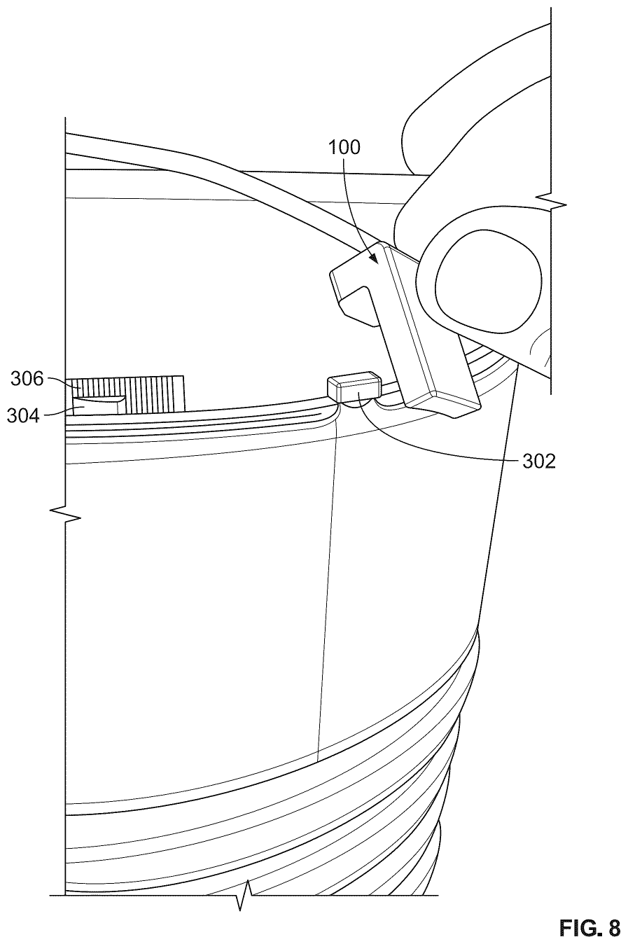

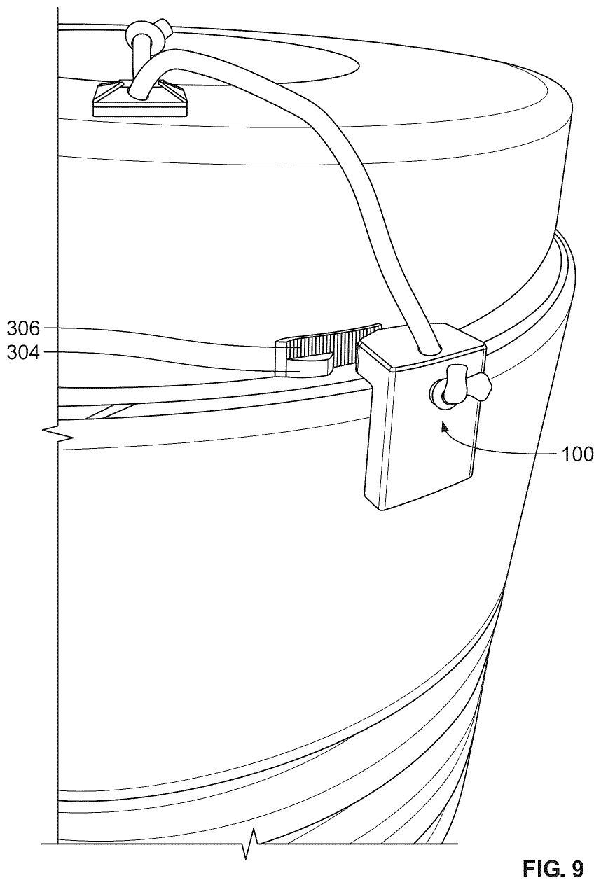

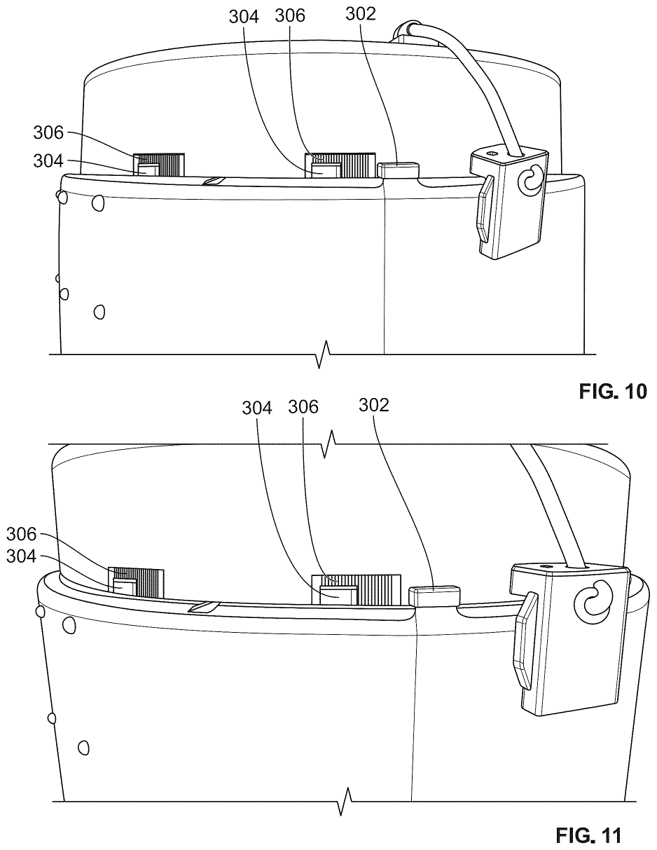

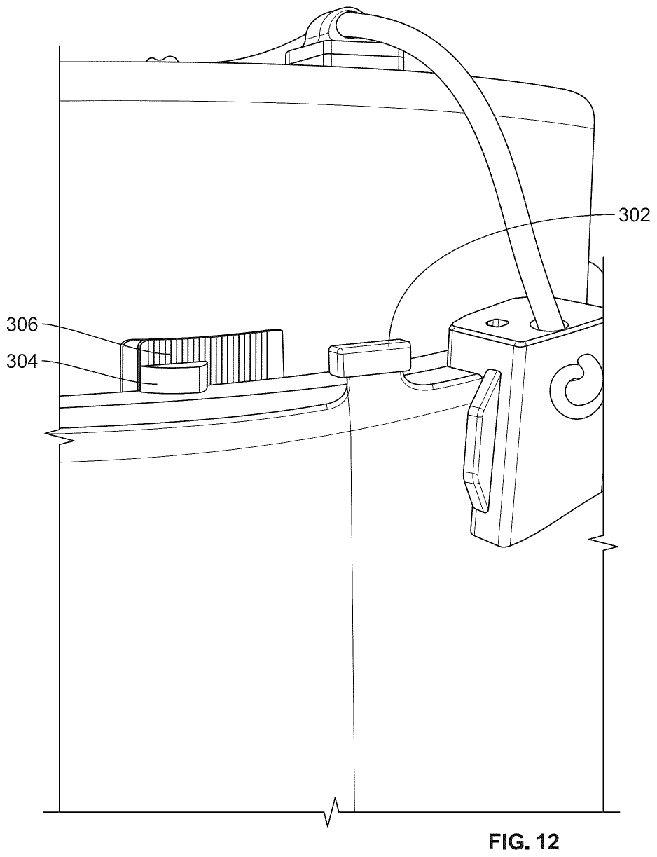

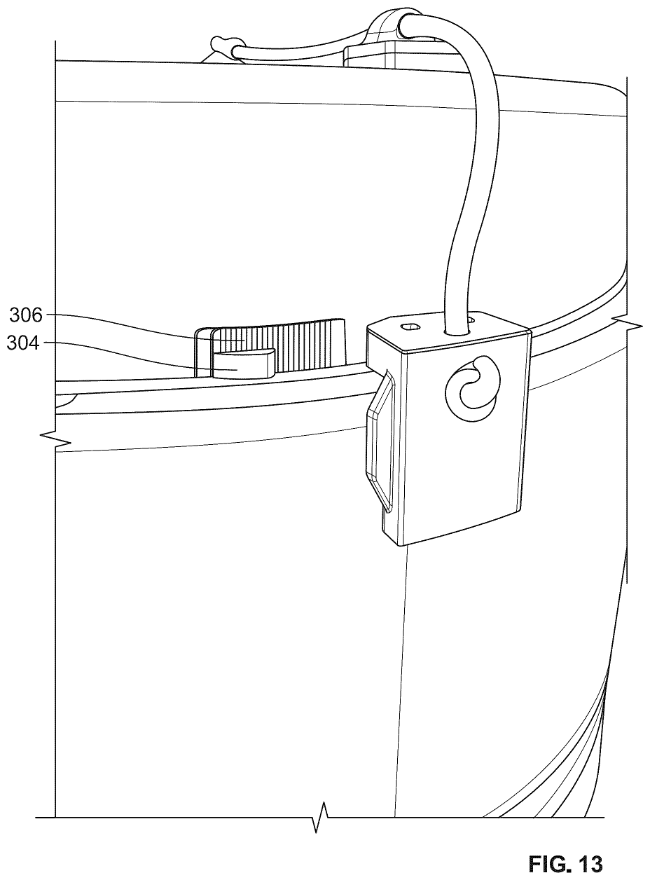

A protrusion 104 or lip extends substantially perpendicularly from the elongate body 102. The protrusion 104 is configured to interact with a stopping mechanism of a tamper-resistant container and serves as a main functional component of the device (e.g., device 100 of FIGS. 1-3 and 8-9, or device 200 of FIGS. 4-7 and 10-13), interacting with the stopping mechanism (e.g., stopping mechanism 302 of FIGS. 8-13) of the tamper-resistant container to facilitate lid removal. The stopping mechanism 302 may generally be located along a peripheral top edge of the body of the tamper-resistant container. As shown in FIG. 1, for example, an underside of the protrusion 104 includes a cavity 106, recess, or depression that is shaped to fit over the stopping mechanism 302 of the tamper-reistant container (e.g., bear can). The recess or cavity 106 disposed within the protrusion 104 is configured to securely engage a stopping mechanism 302. That is, once fitted over the container body stopping mechanism 302, the device 100 is configured to stay in place, allowing an operator to turn the lid with one hand. Thus, the cavity 106 may be shaped to fit the stopping mechanism 302. This ensures the device 100 stays in place during operation, freeing the user's other hand to simply rotate the lid.

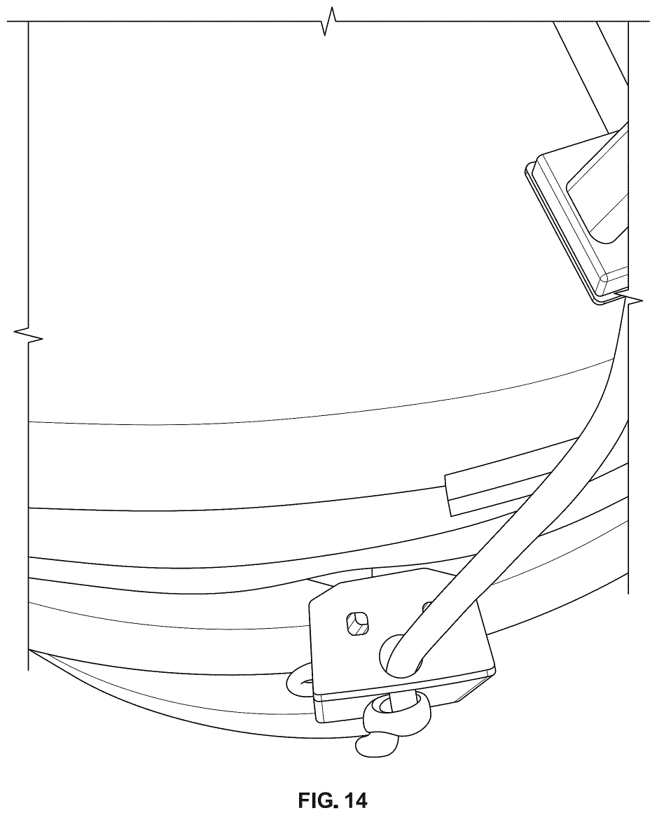

In operation, a user places the device 100 over the stopping mechanism 302 of the tamper-resistant container, aligning the cavity 106 or depression to securely fit over it. When the device 100 is placed over the stopping mechanism 310, as generally illustrated in FIGS. 8-15, the protrusion 104 depresses the flexible portions 306 of the lid 300, located generally around the barbs 304 of the tamper-resistant container lid. Upon turning the lid, the protrusion 104 depresses the flexible portions 306 of the lid around a first barb 304 of the plurality of barbs or other lid protrusions positioned on the container lid. As the lid is rotated, the protrusion 104 of the device 100 continues to press against the flexible portions 306 of the lid, forcing each of the barbs 304 to slide behind the stopping mechanism 302 along an inside path of the tamper-resistant container body, and along a peripheral edge of the protrusion 104, rather than being stopped by the stopping mechanism 302. To this end, at least one edge 112 of the protrusion may be beveled to encourage the barb 304 of the lid to slide behind the protrusion 104 and the stopping mechanism 302. Once the stopping mechanism 302 has been bypassed by all the barbs 304, the lid may continue to rotate freely and ultimately detach from the container body. Once the lid is completely released, a user may access the container's contents. The design ensures that users can open the container with a single hand, eliminating the need to use extra force, tools, or awkward positioning (such as holding the container between their legs).

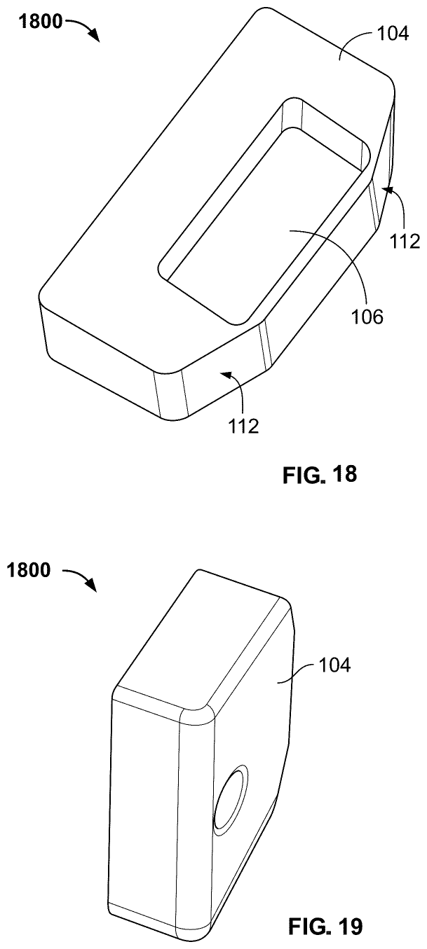

In some embodiments, the device is formed as a cap (i.e., without the elongate body) such that a user may place the cap over the stopping mechanism and turn the lid to separate the lid from the container. FIGS. 18 and 19 illustrate an additional embodiment 1800 of the device that may be formed as a cap. In such embodiments, the cap may interact with the stopping mechanism (e.g., stopping mechanism 302 of FIGS. 8-13) of the tamper-resistant container to facilitate lid removal. As with the protrusion 104, the underside of the cap may include a cavity 106, recess, or depression that is shaped to fit over the stopping mechanism 302 of the tamper-reistant container (e.g., bear can). The recess or cavity disposed within the cap is configured to securely engage a stopping mechanism 302. That is, once fitted over the container body stopping mechanism 302, the cap allows an operator to turn the lid with one hand. Thus, the cavity may be shaped to fit the stopping mechanism 302. This assists with proper placement of the cap over the stopping mechanism and enables the cap to stay in place during operation, freeing the user's other hand to simply rotate the lid.

In operation, a user places the cap over the stopping mechanism 302 of the tamper-resistant container, aligning the cavity 106 or depression to securely fit over it. When the cap is placed over the stopping mechanism 310, the cap depresses the flexible portions 306 of the lid 300, located generally around the barbs 304 of the tamper-resistant container lid. Upon turning the lid, the cap depresses the flexible portions 306 of the lid around a first barb 304 of the plurality of barbs or other lid protrusions positioned on the container lid. As the lid is rotated, the device continues to press against the flexible portions 306 of the lid, forcing each of the barbs 304 to slide behind the stopping mechanism 302 along an inside path of the tamper-resistant container body, and along a peripheral edge of the protrusion 104, rather than being stopped by the stopping mechanism 302. To this end, at least one edge 112 of the cap may be beveled to encourage the barb 304 of the lid to slide behind the cap and the stopping mechanism 302. Once the stopping mechanism 302 has been bypassed by all the barbs 304, the lid may continue to rotate freely and ultimately detach from the container body. Once the lid is completely released, a user may access the container's contents.

The device 100 is a compact and ergonomic tool designed to assist users in easily opening bear-resistant food containers. The device 100 also provides several benefits, including one-handed operation. That is, the device eliminates the need for the user to push the barbs in while turning the lid, making the tamper-resistant container much easier to open and use. Instead, a user may be able to open the container by simply placing the opener over the stopping mechanism and rotating the lid. This lets the user open the tamper-resistant container using only their hands and eliminates the need to hold the tamper-resistant container between a user's legs or under an arm and the need to use both hands, excessive force, or awkward positioning to release the lid. The device 100 is also portable and lightweight, making it easy to store, carry, and attach to outdoor gear. The device is durable and enables a tamper-resistant canister to be opened without compromising the canister's integrity, ensuring continued protection against wildlife.

The device 100 does not compromise the integrity or function of the tamper-resistant container itself. Due to the geometry and removability of the device 100, the tamper-resistant container itself and the locking mechanism are not damaged and keep items safe within the container.

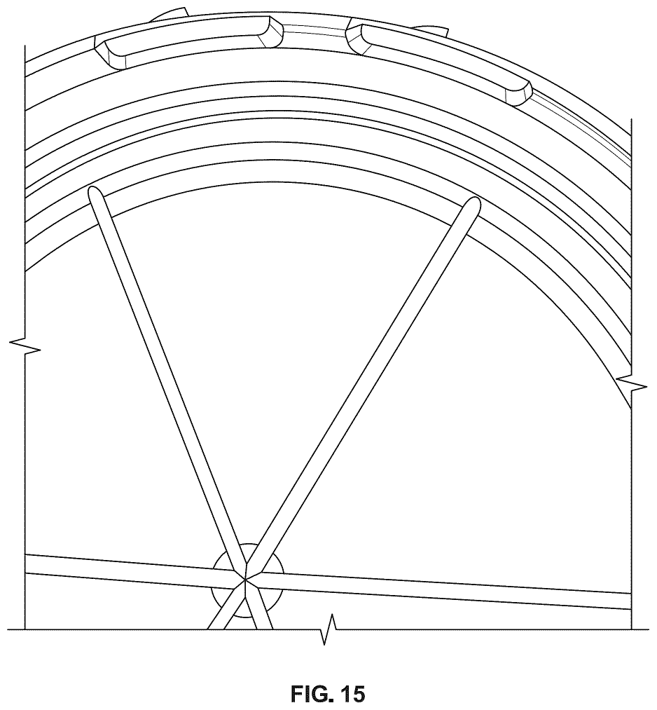

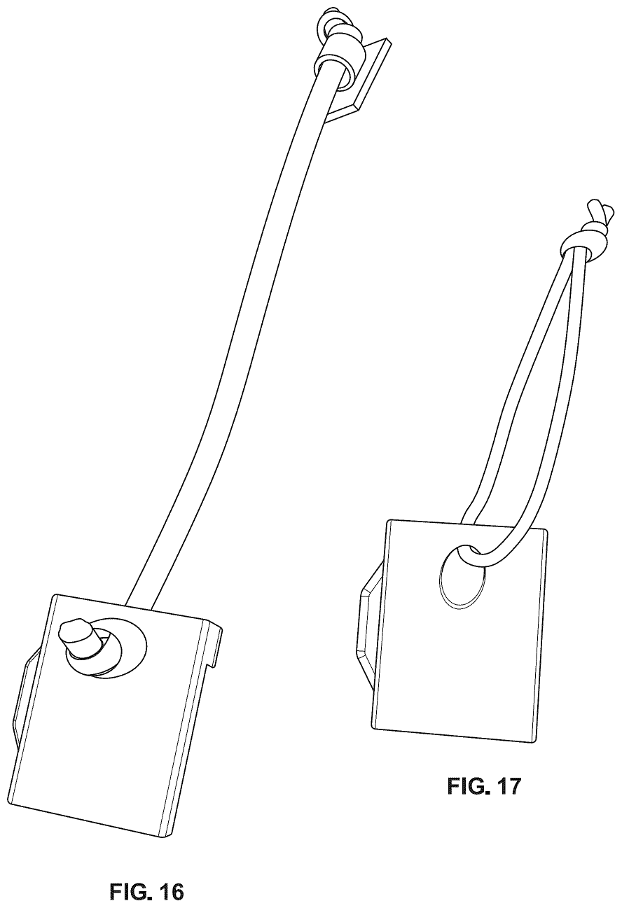

As discussed herein, a plurality of apertures may be integrated within one or more areas of the device 100. The device 100 can be stored and transported along with the tamper-resistant canister by attaching it to a rope, cord, or keychain using one or more of the integrated apertures (e.g., an integrated loop or hole 108 in the elongate body 102 or the aperture assembly 110 of the protrusion 104). FIGS. 16 and 17 are perspective views of an attachment assembly according to embodiments of the disclosure. The rope or cord can be affixed to an external surface of the container body or lid, as is shown in FIGS. 16-17, or attached to a keychain for convenient storage via the aperture assembly 110. The compact size of the device ensures that it is portable and convenient, making it easy to carry in a pocket, attach to a keychain, or store alongside camping gear. The device 100 may include one or more textured surfaces or ridges for improved grip and handling in outdoor conditions.

In an alternative embodiment, a device 200 for opening a tamper-resistant container may include an auxiliary tab 112 configured to engage with one or more rotating disc lock slots found on some tamper-resistant containers. FIGS. 4-6 are an additional perspective views of the opener including an auxiliary tab according to embodiments of the disclosure. This feature allows a user to open both styles of tamper-resistant container using a single device. In further embodiments, the auxiliary tab may be used to depress other stopping mechanisms, such as metal “spring” type mechanisms on the lid or body of a tamper-resistant container.

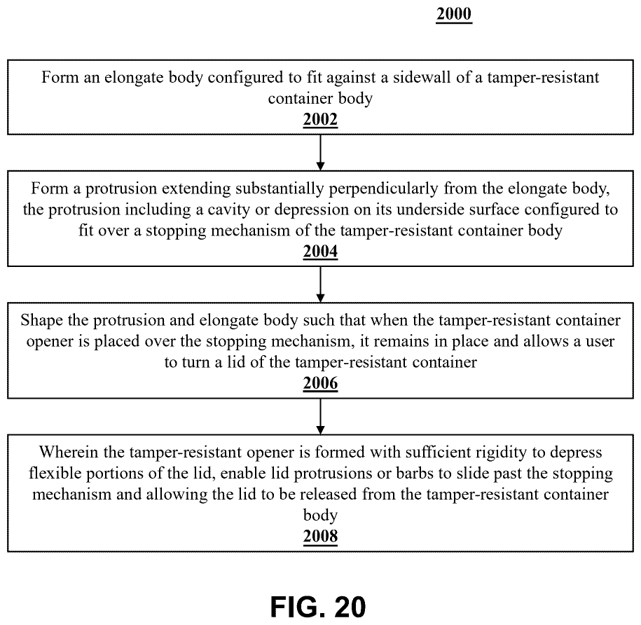

Methods of forming a device for opening a tamper-resistant container such as devices 100 and 200 are contemplated. Methods may include forming the device including forming one or more of the components as described herein. FIG. 20 is a flowchart of an example process 2000. In some implementations, one or more process blocks of FIG. 20 may be performed by the device as described herein (e.g., device 100). As shown in FIG. 20, process 2000 may include forming an elongate body configured to fit against a sidewall of a tamper-resistant container body (block 2002). As also shown in FIG. 20, process 2000 may include forming a protrusion extending substantially perpendicularly from the elongate body, the protrusion including a cavity or depression on its underside surface configured to fit over a stopping mechanism of the tamper-resistant container body (block 2004). As further shown in FIG. 20, process 2000 may include shaping the protrusion and elongate body such that when the tamper-resistant container opener is placed over the stopping mechanism, it remains in place and allows an user to turn a lid of the tamper-resistant container, (block 2006). As also shown in FIG. 20, process 2000 may include where the tamper-resistant opener is formed with sufficient rigidity to depress flexible portions of the lid, enabling lid protrusions or barbs to slide past the stopping mechanism and allowing the lid to be released from the tamper-resistant container body (block 2008).

Although FIG. 20 shows example blocks of process 2000, in some implementations, process 2000 may include additional blocks, fewer blocks, different blocks, or differently arranged blocks than those depicted in FIG. 20. For instance the process 2000 may include forming a cap including a cavity or depression on its underside surface configured to fit over a stopping mechanism of the tamper-resistant container body, and omit the step of forming the elongate body. Additionally, or alternatively, two or more of the blocks of process 2000 may be performed in parallel.

The process 2000 may further comprise forming a hole or loop within the elongate body, allowing users to attach the device to a rope, carabiner, or keychain for easy access, and forming an auxiliary tab on a lateral edge of the elongate body, where the auxiliary tab is shaped to match the slot dimensions of tamper-resistant containers featuring rotating disc lock mechanisms.

The device 100 and/or any of its components can be formed from plastic or other durable, sufficiently rigid material, ensuring it has the necessary strength and rigidity to deform the tamper-resistant container lid while remaining lightweight and portable. For instance, the device 100 may be constructed from a rigid plastic material, such as ABS or polycarbonate, that provides adequate strength to deform the tamper-resistant container lid without being too brittle. Different components or sub-components may be formed from different materials. In alternative embodiments, the device may be made from composite materials or lightweight metals.

The device 100 may be formed by any suitable material manufacturing process, such as injection molding, cast molding, additive manufacturing, etc., or any suitable method that provides structural integrity, durability, and lightweight portability, and may vary depending on cost and scalability requirements.

The specification describes, and the accompanying figures illustrate, the structure, functionality, and operation of possible implementations of the apparatus, and methods of making and using the apparatus, according to various embodiments of the present disclosure. Although specific embodiments of the present disclosure have been described, it will be understood by those of skill in the art that there are other embodiments that are equivalent to the described embodiments. Accordingly, it is to be understood that the disclosure is not to be limited by the specific illustrated embodiments, but only by the scope of the appended claims.

From the above description, it can be seen that the present disclosure provides an apparatus and methods of making and using the apparatus. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the foregoing written description of the disclosure enables one of ordinary skill to make and use what is considered presently to be the best mode thereof, those of ordinary skill will understand and appreciate the existence of alternatives, adaptations, variations, combinations, and equivalents of the specific embodiment, method, and examples herein. Those skilled in the art will appreciate that the above disclosures are exemplary only and that various modifications may be made within the scope of the present disclosure. In addition, while a particular feature of the teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description or the claims, such terms are intended to be inclusive in a manner similar to the term “comprising.”

Other embodiments of the teachings will be apparent to those skilled in the art from consideration of the specification and practice of the teachings disclosed herein. The disclosure should therefore not be limited by the described embodiment, method, and examples, but by all embodiments and methods within the scope and spirit of the disclosure. Accordingly, the present disclosure is not limited to the specific embodiments as illustrated herein.

1. An apparatus for opening a tamper-resistant container, comprising:
an elongate body configured to fit against a sidewall of a tamper-resistant container body;
a protrusion extending substantially perpendicularly from the elongate body, the protrusion including a cavity or depression on its underside surface, the cavity or depression configured to fit over a stopping mechanism of the tamper-resistant container body;
wherein, when the protrusion is fitted over the stopping mechanism, the apparatus remains in place and allows a user to turn a lid of the tamper-resistant container;
wherein turning the lid causes the protrusion to depress a flexible portion of the lid, enabling lid protrusions to slide past the stopping mechanism and allowing the lid to be released from the tamper-resistant container body.

2. The apparatus of claim 1, wherein the apparatus is formed from a rigid material capable of deforming the tamper-resistant lid sufficiently to bypass the stopping mechanism.

3. The apparatus of claim 1, wherein at least one of the elongate body and the protrusion includes an attachment mechanism receiving assembly configured to receive an attachment mechanism for securing the apparatus to an external surface of the tamper-resistant container body or lid.

4. The apparatus of claim 1, wherein the attachment mechanism receiving assembly comprises a loop, hole, or slot and the attachment mechanism comprises a rope, cord, or keychain.

5. The apparatus of claim 1, wherein the protrusion is integrally formed with the elongate body through an injection molding, cast molding, or additive manufacturing process.

6. The apparatus of claim 1, wherein the cavity is shaped to be fitted over the stopping mechanism without requiring manual holding during lid rotation.

7. The apparatus of claim 1, further comprising an additional tab extending from a side wall of the elongate body, the additional tab configured to fit into a rotating lock slot of a tamper-resistant container to enable release of the lid secured by a rotating lock mechanism.

8. The apparatus of claim 1, wherein the protrusion is dimensioned to accommodate one or more variations in tamper-resistant container designs while maintaining functionality in depressing flexible portions of the lid.

9. The apparatus of claim 1, wherein the cavity or depression within the protrusion is contoured to engage with a plurality of shapes and sizes of stopping mechanisms used in tamper-resistant containers.

10. The apparatus of claim 1, wherein the apparatus is removable and does not alter the structural integrity or functionality of the tamper-resistant container or its locking mechanism.

11. The apparatus of claim 1, wherein the tamper-resistant container is a bear can or canister.

12. A kit for separating a lid of a tamper-resistant container from a container body, comprising:
a device for assisting in the separation of the lid from the tamper-resistant container, the device comprising:
an elongate body configured to rest against a sidewall of the container body;
a protrusion extending perpendicularly from the elongate body, the protrusion comprising a cavity disposed within an underside surface of the protrusion, wherein the cavity is configured to fit over a stopping mechanism disposed on the container body, and wherein, when the lid is rotated, the protrusion is configured to depress a flexible portion of a lid around a barb extending from the lid such that the barb slides behind the stopping mechanism and the protrusion to enable the lid to be separated from the container body; and
an attachment mechanism receiving assembly configured to receive an attachment mechanism for securing the apparatus to an external surface of the tamper-resistant container body or lid.

13. The kit of claim 12, wherein attachment mechanism receiving assembly comprises one or more apertures configured to receive a rope, cord, or keychain.

14. The kit of claim 12, further comprising an additional tab extending from a side wall of the elongate body, the additional tab configured to fit into a rotating lock slot of a tamper-resistant container to enable release of the lid secured by a rotating lock mechanism.

15. An apparatus for opening a tamper-resistant container, comprising:
a cap including a cavity or depression on its underside surface, the cavity or depression configured to fit over a stopping mechanism of the tamper-resistant container body;
wherein, when the cap is fitted over the stopping mechanism, the apparatus remains in place and allows a user to turn a lid of the tamper-resistant container;
wherein turning the lid causes the cap to depress a flexible portion of the lid, enabling lid protrusions to slide past the stopping mechanism and allowing the lid to be released from the tamper-resistant container body.

16. The apparatus of claim 15, wherein the cavity is shaped to be fitted over the stopping mechanism without requiring manual holding during lid rotation.

17. A method of manufacturing a tamper-resistant container opener, comprising:
forming an elongate body configured to fit against a sidewall of a tamper-resistant container body;
forming a protrusion extending substantially perpendicularly from the elongate body, the protrusion including a cavity or depression on its underside surface configured to fit over a stopping mechanism of the tamper-resistant container body;
shaping the protrusion and elongate body such that when the tamper-resistant container opener is placed over the stopping mechanism, it remains in place and allows a user to turn a lid of the tamper-resistant container,
wherein the tamper-resistant opener is formed with sufficient rigidity to depress flexible portions of the lid, enabling lid protrusions or barbs to slide past the stopping mechanism and allowing the lid to be released from the tamper-resistant container body.

18. The method of claim 17, wherein the tamper-resistant container opener is formed using an injection molding process with a plastic material selected for its rigidity and durability.

19. The method of claim 17, further comprising forming an attachment mechanism receiving assembly on a portion of the opener, the attachment mechanism receiving assembly configured to receive an attachment mechanism for attaching the opener to the container.

20. The method of claim 17, further comprising forming an additional tab extending from the elongate body, the tab configured to fit into a rotating lock slot of a tamper-resistant to enable release of a lid secured by a rotating lock mechanism.
